(19) United States
(12) Patent Application Publication
(10) Pub. No.: US 2026/0106725 A1
(43) Pub. Date: Apr. 16, 2026

(54) ELECTRONIC APPARATUS AND CONTROLLING METHOD THEREOF

(71) Applicant: CRYPTO LAB INC., Seoul (KR)

(72) Inventors: Youngjin Bae, Seoul (KR); Myeong Jae Kim, Seoul (KR)

(21) Appl. No.: 19/354,949

(22) Filed: Oct. 10, 2025

(30) Foreign Application Priority Data
Oct. 10, 2024 (KR) 10-2024-0137974
Oct. 1, 2025 (KR) 10-2025-0143513

(51) Int. Cl. H04L 9/00

(52) U.S. Cl. CPC H04L 9/008

(57) ABSTRACT

An electronic device is disclosed. The electronic device includes at least one processor including processing circuitry and memory, the at least one processor configured to obtain a control instruction for generating a one-hot vector with respect to a first ciphertext comprised of a binary vector, obtain length information of the first ciphertext, obtain calculation count based on the length information, obtain a unit vector corresponding to the length information, and generate a second ciphertext indicating a one-hot vector corresponding to the first ciphertext based on the first ciphertext, the length information, the calculation count and the unit vector.

### TECHNICAL FIELD

This disclosure relates to an electronic apparatus and a controlling method thereof, and more particularly, to an electronic apparatus generating a one-hot vector corresponding to a homomorphically encrypted binary vector and a controlling method thereof.

### BACKGROUND ART

In terms of Artificial Intelligence such as vector database search face recognition, a large language model and the like, a process of converting a binary vector into a one-hot vector may be required.

The binary vector may be a vector comprised of 0 and 1. The one-hot vector may mean a binary vector having one 1.

Homomorphic encryption may be required for an AI model to provide a service associated with encrypted data. Herein, an efficient algorithm for necessarily converting a homomorphically encrypted binary vector into a one-hot vector may be needed.

### DISCLOSURE OF INVENTION

### Solution to Problem

The subject matter of the disclosure is to solve the above problem, and the object of the disclosure is to an electronic apparatus obtaining a length corresponding to a binary vector, and using a unit vector and calculation count based on the length to generate a one-hot vector, and a controlling method thereof.

According to one embodiment, an electronic apparatus includes at least one processor including processing circuitry and memory, and the at least one processor obtains a control instruction for generating a one-hot vector with respect to a first ciphertext comprised of a binary vector, obtains length information of the first ciphertext, obtains calculation count based on the length information, obtains a unit vector corresponding to the length information, and generates a second ciphertext that indicates a one-hot vector corresponding to the first ciphertext based on the first ciphertext, the length information, the calculation count and the unit vector.

The first ciphertext may be a binary vector having a value of 0 or 1, and the second ciphertext may be a one-hot vector having only one value of 1.

The unit vector may be a vector including a value of 1 by as much as the length information.

The first ciphertext may be a homomorphically encrypted vector, and the unit vector may be a plaintext vector.

The at least one processor may apply the calculation count, the unit vector and the first ciphertext to a first function to obtain first intermediate information, obtain filter information based on the length information, apply the calculation count, the unit vector, the first intermediate information and the filter information to a second function to obtain second intermediate information, and apply a plurality of intermediate values included in the second intermediate information to a third function to obtain the second ciphertext.

The first function may be a function indicating an OR calculation that identifies whether a value of 1 is present based on a predetermined group unit, the second function may be a function removing a value of 1 selectively based on a predetermined group unit, and the third function may be a function indicating a calculation of multiplying a plurality of intermediate values.

The length information may be in a 2ⁿ form, the calculation count may be obtained based on log₂ N, and N may be the length information.

The first function may be

$${A}_{k} = \vec{1} - ( \vec{1} - {A}_{k - 1} ) ( \vec{1} - {rot}_{\frac{N}{{2}^{k}}} ( {A}_{k - 1} ) )$$

$$k = 1 , … , x - 1 ,$$

k may be a calculation unit increased from 1 to x−1, Ak may be the first intermediate information, \vec{1} may be the unit vector,

$${rot}_{\frac{N}{{2}^{k}}} ( {A}_{k - 1} )$$

may be a function rotating a component in a predetermined direction by as much as

$$\frac{N}{{2}^{k}}$$

with respect to Aₖ₋₁, and N may be the length information.

The second function may be

$${B}_{k} = {A}_{k} \cdot ( \vec{1} - {rot}_{\frac{N}{{2}^{k + 1}}} ( {A}_{k} \cdot {h}_{k} ) )$$

$$k = 0 , … , x - 1 ,$$

k may be a calculation unit increased from 0 to x−1, Bk may be the second intermediate information, hk may be the filter information, Aₖ·hₖ may be a value of multiplication of the first intermediate information and the filter information,

$${rot}_{\frac{N}{{2}^{k + 1}}} ( {A}_{k} \cdot {h}_{k} )$$

may be a function rotating a component in a predetermined direction by as much as

$$\frac{N}{{2}^{k + 1}}$$

with respect to Aₖ·hₖ, and A₀ may be the first ciphertext.

The third function may be C=B₀·B₁· . . . ·Bₓ₋₁, C may be the second ciphertext, and x may be the calculation count.

According to one embodiment, a controlling method of an electronic apparatus includes obtaining a control instruction for generating a one-hot vector with respect to a first ciphertext comprised of a binary vector, obtaining length information of the first ciphertext, obtaining calculation count based on the length information, obtaining a unit vector corresponding to the length information, and generating a second ciphertext that indicates a one-hot vector corresponding to the first ciphertext based on the first ciphertext, the length information, the calculation count and the unit vector.

The first ciphertext may be a binary vector having a value of 0 or 1, and the second ciphertext may be a one-hot vector having only one value of 1.

The unit vector may be a vector including a value of 1 by as much as the length information.

The first ciphertext may be a homomorphically encrypted vector, and the unit vector may be a plaintext vector.

The obtaining a second ciphertext may include applying the calculation count, the unit vector and the first ciphertext to a first function to obtain first intermediate information, obtaining filter information based on the length information, applying the calculation count, the unit vector, the first intermediate information and the filter information to a second function to obtain second intermediate information, and applying a plurality of intermediate values included in the second intermediate information to a third function to obtain the second ciphertext.

The first function may be a function indicating an OR calculation that identifies whether a value of 1 is present based on a predetermined group unit, the second function may be a function removing a value of 1 selectively based on a predetermined group unit, and the third function may be a function indicating a calculation of multiplying a plurality of intermediate values.

The length information may be in a 2ⁿ form, and the calculation count may be obtained based on log₂ N, and N may be the length information.

The first function may be

$${A}_{k} = \vec{1} - ( \vec{1} - {A}_{k - 1} ) ( \vec{1} - {rot}_{\frac{N}{{2}^{k}}} ( {A}_{k - 1} ) )$$

$$k = 1 , … , x - 1 ,$$

k may be a calculation unit increased from 1 to x−1, Ak may be the first intermediate information, \vec{1} may be the unit vector,

$${rot}_{\frac{N}{{2}^{k}}} ( {A}_{k - 1} )$$

may be a function rotating a component in a predetermined direction by as much as

$$\frac{N}{{2}^{k}}$$

with respect to Aₖ₋₁, and N may be the length information.

The second function may be

$$\begin{matrix}{B}_{k} = {A}_{k} \cdot ( \vec{1} - {rot}_{\frac{N}{{2}^{k + 1}}} ( {A}_{k} \cdot {h}_{k} ) ) \\ k = 0 , … , x - 1\end{matrix} ,$$

k may be a calculation unit increased from 0 to x−1, Bk may be the second intermediate information, hk may be the filter information, Aₖ·hₖ may be a value of multiplication of the first intermediate information and the filter information,

$${rot}_{\frac{N}{{2}^{k + 1}}} ( {A}_{k} \cdot {h}_{k} )$$

may be a function rotating a component in a predetermined direction by as much as

$$\frac{N}{{2}^{k + 1}}$$

with respect to Aₖ·hₖ, and A₀ may be the first ciphertext.

The third function may be C=B₀·B₁· . . . ·Bₓ₋₁, C may be the second ciphertext, and x may be the calculation count.

### BRIEF DESCRIPTION OF DRAWINGS

FIG. 1 is a view provided to explain a structure of a network system, according to one embodiment;

FIG. 2 is a view provided to explain a structure of a network system, according to one embodiment;

FIG. 3 is a block diagram illustrating an electronic apparatus, according to one embodiment:

FIG. 4 is a view provided to explain a one-hot vector, according to one embodiment:

FIG. 5 is a view provided to explain an operation for obtaining a one-hot vector, according to one embodiment:

FIG. 6 is a view provided to explain an operation for obtaining a one-hot vector, according to one embodiment:

FIG. 7 is a view provided to explain an algorithm for converting a binary vector into a one-hot vector, according to one embodiment:

FIG. 8 is a view provided to explain a calculation process based on a first function, according to one embodiment:

FIG. 9 is a view provided to explain a result of a partial formula used in an algorithm, according to one embodiment:

FIG. 10 is a view provided to explain filter information, according to one embodiment:

FIG. 11 is a view provided to explain a rotation function, according to one embodiment:

FIG. 12 is a view provided to explain a first calculation process based on a second function, according to one embodiment:

FIG. 13 is a view provided to explain a result of an application of input data to a second function, according to one embodiment:

FIG. 14 is a view provided to explain a second calculation process based on a second function, according to one embodiment:

FIG. 15 is a view provided to explain a second calculation process based on a second function, according to one embodiment:

FIG. 16 is a view provided to explain a one-hot vector corresponding to input data, according to one embodiment; and

FIG. 17 is a view provided to explain an algorithm for converting a binary vector into a one-hot vector, according to one embodiment.

### MODE FOR INVENTION

Hereafter, the subject matter of the present disclosure is described in detail with reference to the accompanying drawings.

General terms currently used as widely as possible are selected as the terms used for the embodiments of the disclosure considering functions in the disclosure, but may be changed based on the intention of those skilled in the art or a judicial precedent, the emergence of a new technology, or the like. In addition, in a specific case, terms arbitrarily chosen by the applicant may be included in the terms used herein. In this case, the meanings of such terms are described in detail in the detailed description of the disclosure. Therefore, the terms used in the disclosure need to be defined based on the meanings thereof and particulars throughout the disclosure rather than simply the names thereof.

In the disclosure, the expressions “have”, “may have”, “include”, or “may include” and the like indicate the existence of a feature (e.g., a numerical value, a function, an operation or an element such as a part and the like), and do not exclude the existence of an additional feature.

The expression of at least one from A or/and B is to be understood as indicating any one of “A” or “B” or “A and B”.

The expression “1st”, “2nd”, “first”, or “second” and the like used in the disclosure, may be used to refer to various elements regardless of their order and/or importance, and may be used merely to differentiate one element from another but not intended to limit the elements.

Based on one element (e.g., a first element) referred to as being “(operatively or communicatively) coupled with/to or connected with/to” another element (e.g., a second element), it is to be understood that one element may connect to another element directly, or through yet another element (e.g., a third element).

In the disclosure, singular forms include plural forms as well, unless explicitly indicated otherwise. In the disclosure, the term “include” or “comprised of” and the like specify the presence of stated features, numbers, steps, operations, elements, parts or combinations thereof but do not imply the exclusion of the presence or addition of one or more other features, numbers, steps, operations, elements, parts or combinations thereof.

In the disclosure, the term “module” or “unit” may perform at least one function or operation, and be implemented by hardware or software or by a combination of hardware and software. Additionally, a plurality of “modules” or a plurality of “units” may be integrated into at least one module and be implemented by at least one processor except for a “module” or a “unit” that needs to be implemented by specific hardware.

In the disclosure, the term “user” may refer to a person who uses an electronic apparatus or an apparatus (e.g., an artificial intelligence electronic apparatus) which uses an electronic apparatus.

Additionally, in the disclosure, a “value” is defined as a concept including a vector as well as a scalar.

A mathematical calculation and computation in each of the steps described hereafter according to the disclosure may be implemented as a computer operation based on a coding method publicly known for the calculation or computation and/or coding devised to fit for the subject matter of the disclosure.

Specific formulas described hereafter are provided as examples among various possible alternatives, and the scope of the right to the subject matter of the disclosure is not to be interpreted as being limited to the formulas described herein.

In the disclosure, symbols are determined as follows for convenience of description.

a←D: select an element a based on a distribution D

s1, s2∈R:S1, S2 as elements respectively belonging to a set R mod (q): a modular calculation with an element q

└·┐: round internal values

Hereafter, various embodiments of the disclosure are described in detail with reference to the accompanying drawings.

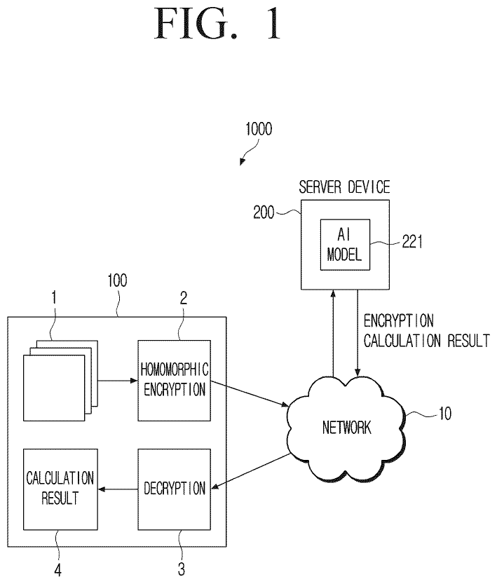

FIG. 1 is a view provided to explain a structure of a network system 1000, according to one embodiment.

Referring to FIG. 1, an electronic apparatus 100 and a server device 200 may communicate with each other through a network 10. The network 10 may be implemented as various types of wired/wireless communication networks, broadcast communication networks, optical communication networks, cloud networks and the like, and each of the devices may also be connected based on methods such as Wi-Fi, Bluetooth, Near Field Communication (NFC) and the like, without a separate medium.

In FIG. 1, one electronic apparatus 100 is illustrated, but the electronic apparatus 100 may be implemented in a plurality of different forms. As one example, the electronic apparatus 100 may be various types of apparatuses such as a smartphone, a tablet, a PC, a laptop PC, a home server, a kiosk, a game console, a camera and the like. Additionally, the electronic apparatus 100 may also be implemented in the form of a home appliance to which IoT functions are applied.

As one example, in the case where the electronic apparatus 100 is provided with a camera, the electronic apparatus 100 may capture images of one or more original data 1 directly and obtain the images. In the case where the electronic apparatus 100 is provided with no camera, the electronic apparatus 100 may receive original data 1 through various types of wired or wireless interfaces from an external device (e.g., a camera, a memory stick and the like) and store the original data. In the embodiments of the disclosure, the original data 1 may be a photo image, but not necessarily limited thereto, and may also be a graphic image. Alternatively, the original data 1 may be a video content including a plurality of image frames.

The electronic apparatus 100 may perform homomorphic encryption 2 with respect to one or more original data, obtain a homomorphic ciphertext, and then transmit the homomorphic ciphertext to the server device 200 through the network 10.

In this case, the leakage of the original data 1 may be caused due to hacking, or by a manager of the server device 200, in the process of transmission. However, in the case where the original data are transmitted in the form of a homomorphic ciphertext, the original data cannot be identified despite the leakage of the original data. Accordingly, security associated with the user's personal information or physical feature may improve.

A homomorphic encryption algorithm generating a homomorphic ciphertext may vary, but in the embodiments of the disclosure, performing homomorphic encryption by using a CKKS scheme or a CKKS scheme-based modified algorithm is described.

To transmit the original data in the form of a homomorphic ciphertext, the electronic apparatus 100 may perform encoding. In the case of homomorphic encryption, encoding may be a task of converting data into an encryptable form. Since homomorphic encryption is based on a mathematical structure (e.g., a polynomial calculation), the original data 1 may be converted into a form processible by the homomorphic encryption algorithm, and then homomorphic encryption may be performed.

In the homomorphic encryption, slot encoding and coefficient encoding may be ordinarily used.

The slot encoding is a method by which data to be encrypted are allocated to a plurality of slots, and then encoded based on a total slot unit. The slot may mean a data unit that can be stored in parallel in one homomorphic ciphertext. In the case where a ciphertext is expressed in the form of a polynomial, coefficients or roots of the polynomial may function as each slot. If one ciphertext is comprised of a total of n numbers of slots, n numbers of values may be encoded or calculated at the same time. In other words, as slot encoding is performed, a parallel calculation with respect to a homomorphic ciphertext may be performed. The slot encoding method may vary depending on a homomorphic encryption algorithm. The above-described CKKS scheme may perform slot encoding by using Fast Fourier Transform (FFT).

The coefficient encoding is a method by which data to be encrypted are converted into a polynomial form, and coefficients of the polynomial are converted into encrypted values. The above-described CKKS scheme may perform coefficient encoding by using Discrete Fourier Transform (DFT).

According to one embodiment, the electronic apparatus 100 may perform CinS encoding. The CinS encoding method means that slot encoding is performed, and then DFT is performed with respect to a plurality of slot sections rather than entire slots, to perform encoding. Detailed descriptions in relation to this are provided hereafter.

In the disclosure, data encoded based on the CinS encoding method is referred to as CinS encoding data. The electronic apparatus 100 transmits, to the server device 200, a homomorphic ciphertext in which CinS encoding data is homomorphically encrypted 2.

The server device 200 is device that performs a calculation with respect to a homomorphic ciphertext (i.e., one or more homomorphically encrypted original data) provided from the electronic apparatus 100 in a homomorphically encrypted state, to provide an encryption calculation result. The server device 200 may be implemented in various different forms such as a web server, a cloud server and the like.

In the server device 200, an AI model 221 for performing a calculation in an encryption state may be stored. In the case where original data are received and a calculation based on the original data is performed as described above, the AI model 221 may be a convolutional neural network (CNN), but not limited thereto.

In detail, the AI model 221 may perform various calculations with respect to a homomorphic ciphertext encrypted based on a homomorphic encryption (e.g., a CKKS scheme) technology, to output results of the calculations in the form of a homomorphic ciphertext. Hereafter, a calculation result output in the form of a homomorphic ciphertext is referred to as an encryption calculation result.

In the case where the AI model 221 is comprised of CNN, the AI model 221 of the server device 200 performs a depthwise convolution calculation or a convolution calculation by using a model parameter with respect to a homomorphic ciphertext transmitted from the electronic apparatus 100. Hereafter, such a calculation method is described in detail.

The server device 200 transmits an encryption calculation result to the electronic apparatus 100 through the network 10. The electronic apparatus 100 may decrypt the received encryption calculation result 3, and provide the calculation result 4 to the user. A method of providing the result may vary depending on the sort of configuration of the electronic apparatus 100.

As one example, in the case where the electronic apparatus 100 is provided with a built-in display, or connected with an external display (e.g., a monitor), the electronic apparatus may display the decrypted calculation result 4.

As one example, in the case where the electronic apparatus 100 is provided with a speaker, the electronic apparatus may also output a voice message corresponding to the calculation result through the speaker.

As one example, in the case where the electronic apparatus 100 performs communication with another terminal device (e.g., a smartphone and the like), the electronic apparatus may also transmit the decrypted calculation result to the terminal device.

As one example, in the case where the AI model 221 is a model trained to diagnose whether there is a disease, the calculation result may include information as to whether there is a disease diagnosed based on original data 1 of the user, information on the sort of the disease, the progression of the disease and the like.

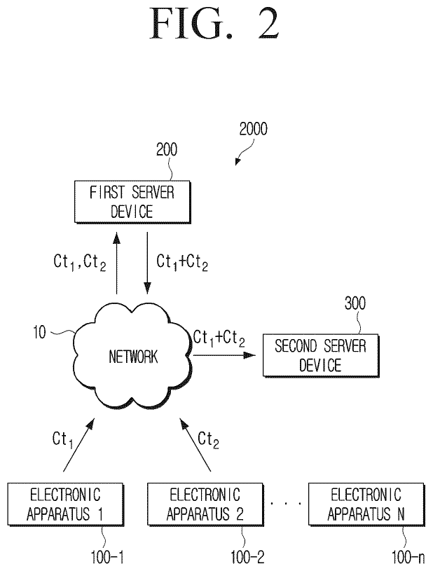

FIG. 2 is a view provided to explain a structure of a network system 2000, according to one embodiment.

Referring to FIG. 2, the network system may include a plurality of electronic apparatuses 100-1-100-n, a first server device 200, a second server device 300, and each of the elements may be connected with one another through a network 10.

The network 10 may be implemented as various types of wired/wireless communication networks, broadcast communication networks, optical communication networks, cloud networks and the like, and each of the devices may also be connected based on methods such as Wi-Fi, Bluetooth, Near Field Communication (NFC) and the like, without a separate medium.

In FIG. 2, a plurality of electronic apparatuses 100-1-100-n is illustrated, but the plurality of electronic apparatuses may not be necessarily used, and one apparatus may also be used. As one example, the electronic apparatuses 100-1-100-n may be implemented as various types of apparatuses such as a smartphone, a tablet, a game console, a PC, a laptop PC, a home server, a kiosk and the like. Additionally, the electronic apparatuses may also be implemented in the form of a home appliance to which IoT functions are applied.

The user may input various types of information through the electronic apparatuses 100-1-100-n that are used by the user. The input information may be stored in the electronic apparatuses 100-1-100-n themselves, but may also be transmitted to and stored in an external device for the reasons of storage capacity, security and the like. In FIG. 2, the first server device 200 may play a role in storing such information, while the second server device 300 may play a role in using all or part of the information stored in the first server device 200.

Each of the electronic apparatuses 100-1-100-n may homomorphically encrypt the input information, and transmit a homomorphic ciphertext to the first server device 200.

Each of the electronic apparatuses 100-1-100-n may include, in a ciphertext, an encryption noise, i.e., an error, calculated in a process of performing homomorphic encryption. In detail, a homomorphic ciphertext generated in each of the electronic apparatuses 100-1-100-n may be produced in the way that a result value including a message and an error value is restored in the case where the homomorphic ciphertext is decrypted by using a secret key later.

As one example, the homomorphic ciphertext generated in the electronic apparatuses 100-1-100-n may be generated to satisfy the following features in the case where the homomorphic ciphertext is decrypted by using a secret key.

$$Dec ( ct , sk ) = < ct , sk >= M + e ( mod q ) \qquad [ Formula 1 ]$$

Herein, <, > means a usual inner product, ct means a ciphertext, sk means a secret key, M means a plaintext message, e means an encryption error value, and mod q means a modulus of the ciphertext. Herein, q needs to be selected to be greater than a result value M at which a scaling factor Δ is multiplied by a message. In the case where an absolute value of an error value e is sufficiently less than M, a decryption value M+e of the ciphertext is a value enabling replacement of an original message with identical precision in a significant figure calculation. Among decrypted data, an error may be disposed toward the least significant bit LSB, while M may be disposed toward the second least significant bit.

In the case where the size of the message is too small or too big, the size of the message may also be adjusted by using the scaling factor. If the scaling factor is used, a message in the form of a real number as well as a message in the form of an integer may be encrypted, leading to significant improvement in availability. Additionally, as the size of the message is adjusted by using the scaling factor, the size of an area where messages are present in a ciphertext following the performance of a calculation, i.e., an effective area, may also be adjusted.

According to an embodiment, the ciphertext module q may be set in various forms for use. As one example, the modulus of the ciphertext may be set in the form of q=Δ^{L} (scaling factor Δ to the power of exponent). In the case where Δ is 2, the modulus of the ciphertext may be set to a value such as q=210.

Additionally, the homomorphic ciphertext according to the disclosure is described under the assumption that a fixed point is used, but may be applied even in the case where a floating point is used.

The first server device 200 may store a received homomorphic ciphertext in a ciphertext state, without decrypting the received homomorphic ciphertext.

The second server device 300 may request a specific processing result with respect to the homomorphic ciphertext from the first server device 200. The first server device 200 may perform a specific calculation at the request of the second server device 300, and then transmit a result of the calculation to the second server device 300.

As one example, in the case where ciphertexts ct1, ct2 transmitted by two electronic apparatuses 100-1, 100-2 are stored in the first server device 200, the second server device 300 may request, from the first server device 200, a value at which data provided from the two electronic apparatuses 100-1, 100-2 are added. The first server device 200 may perform a calculation of adding two ciphertexts at the request, and then transmit a result value ct1+ct2 of the calculation to the second server device 300.

Considering the attribute of a homomorphic ciphertext, the first server device 200 may perform a calculation in a non-decryption state, and a result value of the calculation may be in the form of a ciphertex. In the disclosure, a result value obtained based on a calculation is referred to as a calculation result ciphertext.

The first server device 200 may transmit a calculation result ciphertext to the second server device 300. The second server device 300 may decrypt the received calculation result ciphertext, to obtain calculation result values of data included in each homomorphic ciphertext.

Meanwhile, the electronic apparatus 100 may obtain a homomorphic ciphertext by using a residual number system (RNS) modulus including a plurality of moduli having a size corresponding to a word size of the electronic apparatus 100, and perform a calculation with respect to the homomorphic ciphertext by using rational rescale. According to one or more embodiments, the plurality of moduli may include sprout moduli comprised of multiplication of decimals having a size less than or equal to the word size, and the electronic apparatus 100 may perform various calculations (e.g., a key switching calculation and the like) with respect to the homomorphic ciphertext by using the sprout moduli. According to one or more embodiments, the electronic apparatus 100 may upscale the RNS modulus to generate an intermediate modulus, perform a key switching calculation with respect to the intermediate modulus, and rescale the intermediate modulus in which the key switching calculation is performed, to perform the key switching calculation with respect to the homomorphic ciphertext.

Accordingly, the electronic apparatus 100 may perform an efficient multiplication calculation while minimizing the number of RNS modulus, thereby enabling a more rapid calculation of the homomorphic ciphertext.

Meanwhile, in FIG. 2, a first electronic apparatus and a second electronic apparatus perform encryption, while the second server device performs decryption, but not be limited thereto.

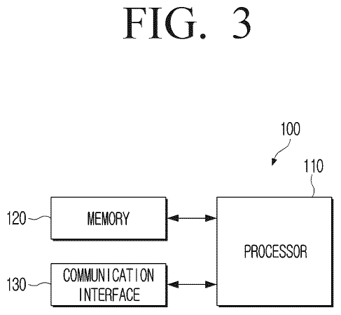

FIG. 3 is a block diagram provided to explain a configuration of an electronic apparatus, according to one embodiment.

Referring to FIG. 3, the electronic apparatus 100 may include at least one processor 110 including processing circuitry and memory 120.

As one example, the electronic apparatus 100 may further include a communication interface 130. The electronic apparatus 100 may receive information associated with a calculation instruction from an external device or an external server through the communication interface 130.

That at least one processor 110 may obtain a control instruction for generation a one-hot vector with respect to a first ciphertext A comprised of binary vectors.

The at least one processor 110 may obtain length information N of the first ciphertext A.

The at least one processor 110 may obtain calculation count (or calculation time or a number of calculation or operation count or a number of operations) x based on the length information N.

The at least one processor 110 may obtain a unit vector corresponding to the length information N.

The at least one processor 110 may generate a second ciphertext C indicating the one-hot vector corresponding to the first ciphertext A based on the first ciphertext A, the length information N, the calculation count x and the unit vector.

The first ciphertext A may be a binary vector having a value of 0 or 1.

The second ciphertext C may be a one-hot vector having only one value of 1.

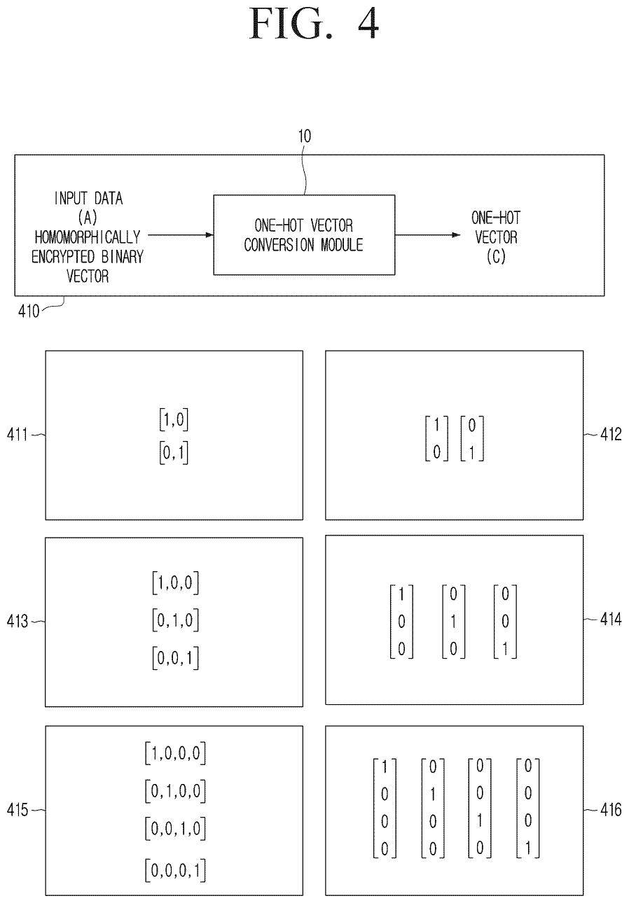

An operation of obtaining the one-hot vector corresponding to the binary vector is described with reference to FIG. 4.

The unit vector may be a vector including a value of 1 by as much as the length information N.

The first ciphertext A may be a homomorphically encrypted vector.

The unit vector may be a plaintext vector.

The at least one processor 110 may obtain a homomorphucally encrypted first ciphertext A. The at least one processor 110 may obtain the second ciphertext C that is a one-hot vector, in a homomorphically encrypted state, without decrypting the homomorphically encrypted first ciphertext A.

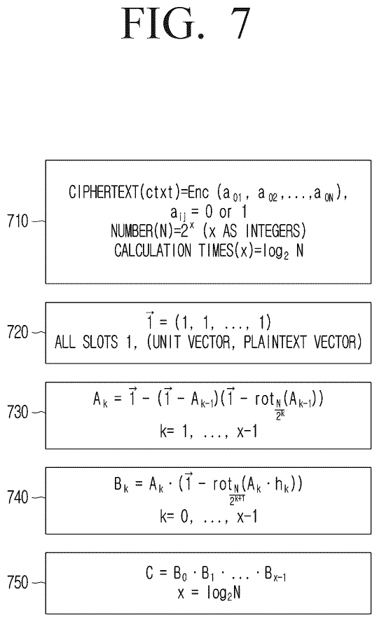

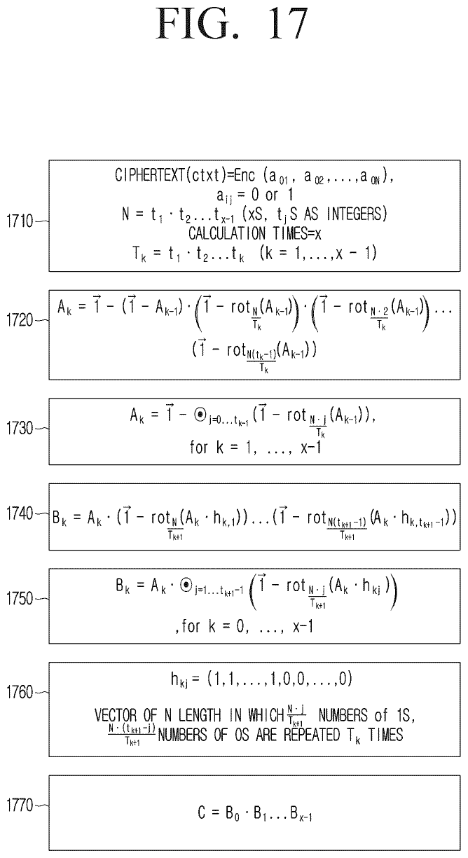

The at least one processor 110 may apply the first ciphertext A, the length information N, the calculation count x and the unit vector to a plurality of predetermined functions (a first function, a second function, a third function) to obtain the second ciphertext C. Detailed descriptions in relation to this are provided with reference to FIGS. 7 and 17.

The at least one processor 110 may apply the calculation count x, the unit vector and the first ciphertext A to a first function to obtain first intermediate information Ak.

The at least one processor 110 may obtain filter information hk based on the length information N.

The at least one processor 110 may apply the calculation count x, the unit vector, the first intermediate information Ak and the filter information hk to a second function to obtain second intermediate information Bk.

The at least one processor 110 may apply a plurality of intermediate values included in the second intermediate information Bk to a third function to obtain the second ciphertext C.

The first function, the second function and the third function may be different functions.

The first function may be a function indicating an OR calculation that identifies whether a value of 1 is present based on a predetermined group unit. The first function may correspond to formula 730 of FIG. 7 and formulas 1720, 1730 of FIG. 17.

The second function may be a function removing a value of 1 selectively based on a predetermined group unit. The second function may correspond to formula 740 of FIG. 7 and formulas 1740, 1750 of FIG. 17.

The third function may be a function indicating a calculation of multiplying a plurality of intermediate values. The third function may correspond to formula 750 of FIG. 7 and formula 1770 of FIG. 17.

According to one embodiment, the length information N may be in a 2ⁿ form. Descriptions in relation to this are provided with reference to FIG. 7.

The calculation count x may be obtained based on log₂ N.

Herein, N may be length information N.

The first function may be

$$\begin{matrix}{A}_{k} = \vec{1} - ( \vec{1} - {A}_{k - 1} ) ( \vec{1} - {rot}_{\frac{N}{{2}^{k}}} ( {A}_{k - 1} ) ) \\ k = 1 , … , x - 1\end{matrix} .$$

Herein, k may be a calculation unit increased from 1 to x−1.

Additionally, Ak may be first intermediate information Ak.

Additionally, \vec{1} may be a unit vector.

Further,

$${rot}_{\frac{N}{{2}^{k}}} ( {A}_{k - 1} )$$

may be a function rotating a component in a predetermined direction with respect to Aₖ₋₁ by as much as

$$\frac{N}{{2}^{k}} .$$

Furthermore, N may be length information N.

The second function may be

$$\begin{matrix}{B}_{k} = {A}_{k} \cdot ( \vec{1} - {rot}_{\frac{N}{{2}^{k + 1}}} ( {A}_{k} \cdot {h}_{k} ) ) \\ k = 0 , … , x - 1\end{matrix} .$$

Herein, k may be a calculation unit increased from 1 to x−1.

Additionally, Bk may be second intermediate information Bk.

Additionally, hk may be filter information hk.

Additionally, Aₖ·hₖ may be a value of multiplication of the first intermediate information Ak and the filter information hk.

Further,

$${rot}_{\frac{N}{{2}^{k + 1}}} ( {A}_{k} \cdot {h}_{k} )$$

may be a function rotating a component with respect to Aₖ·hₖ in a predetermined direction by as much as

$$\frac{N}{{2}^{k + 1}} .$$

Furthermore, A₀ may be a first ciphertext A.

The third function may be C=B₀·B₁· . . . ·Bₓ₋₁.

Herein, C may be a second ciphertext C.

Additionally, x may be calculation count x.

A calculation process associated with an embodiment of N=4 is described with reference to FIGS. 7-16.

According to one embodiment, the length information N may be implemented based on multiplication of integers such as t₁·t₂ . . . tₓ₋₁. Herein, x, t may be integers respectively. Descriptions in relation to this are provided with reference to FIG. 17.

The electronic apparatus 100 may maintain value 1 of a component corresponding to a predetermined position based on the first function, the second function and the third function, and convert a remaining component into 0. Descriptions in relation to this are provided with reference to 16.

The electronic apparatus 100 may reduce a calculation process in generating a one-hot vector based on the first function, the second function and the third function.

FIG. 4 is a view provided to explain a one-hot vector, according to one embodiment.

Referring to an embodiment 410 of FIG. 4, the electronic apparatus 100 may obtain a one-hot vector based on a one-hot vector conversion module 10. The electronic apparatus 100 may obtain a one-hot vector corresponding to input dace through the one-hot vector conversion module 10.

As one example, the one-hot vector conversion module 10 may be included the electronic apparatus 100.

As one example, input data may be a homomorphically encrypted vector. The input data may include a homomorphically encrypted binary vector. The binary vector may be a vector having a 0 or 1 only as a component.

The one-hot vector conversion module 10 may be a module generating a one-hot vector. The one-hot vector may indicate a vector of which only one item is “1” while the remnants are all “0”. The one-hot vector may be a vector for classifying machine learning, deep learning input data.

The one-hot vector may mean a vector expression of which among a plurality of elements, only one element has a value of “1”, while the remaining elements all have a value of “0”, and the position of the element having the value “1” may indicate a specific category or class.

The one-hot vector may be described as a binary indicator vector.

The one-hot vector conversion module 10 may receive input data including a homomorphically encrypted binary vector. The one-hot vector conversion module 10 may be a module generating a one-hot vector of which the binary vector included in the input data has one value of 1.

If the input data are all 0, the one-hot vector conversion module 10 may return 0 simply rather than a one-hot vector. Accordingly, the binary vector included in the input data must not be 0.

Referring to embodiment 411, a 2-dimension one-hot vector divided in a column is illustrated.

Referring to embodiment 412, a 2-dimension one-hot vector divided in a row is illustrated.

Referring to embodiment 413, a 3-dimension one-hot vector divided in a column is illustrated.

Referring to embodiment 414, a 3-dimension one-hot vector divided in a row is illustrated.

Referring to embodiment 415, a 4-dimension one-hot vector divided in a column is illustrated.

Referring to embodiment 416, a 4-dimension one-hot vector divided in a row is illustrated.

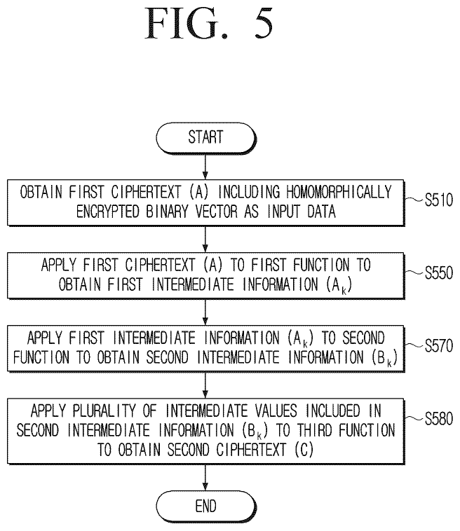

FIG. 5 is a view provided to explain an operation for obtaining a one-hot vector, according to one embodiment.

Referring to FIG. 5, the electronic apparatus 100 may obtain a first ciphertext A including a homomorphically encrypted binary vector as input data (S510).

The electronic apparatus 100 may apply the first ciphertext A to a first function to obtain first intermediate information Ak. The first function may be a function corresponding to formula 730 of FIG. 7.

The electronic apparatus 100 may apply the first intermediate information Ak to a second function to obtain second intermediate information Bk (S570). The second function may be a function corresponding to formula 740 of FIG. 7.

The electronic apparatus 100 may apply a plurality of intermediate values included in the second intermediate information Bk to a third function to obtain a second ciphertext C (S580). The second ciphertext C may be a one-hot vector. Descriptions of the third function are provided with reference to formula 750 of FIG. 7.

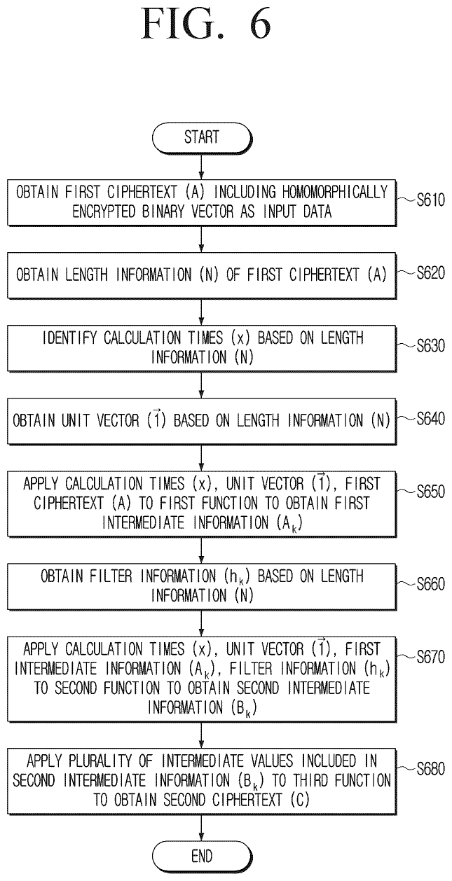

FIG. 6 is a view provided to explain an operation for obtaining a one-hot vector, according to one embodiment.

Referring to FIG. 6, the electronic apparatus 100 may obtain a first ciphertext A including a homomorphically encrypted binary vector as input data (S610).

As the first ciphertext A is obtained, the electronic apparatus 100 may obtain length information N of the first ciphertext A (S620). As one example, the length information may be implemented in a 2ⁿ form.

The electronic apparatus 100 may obtain calculation count x based on the length information N (S630). The calculation count may be obtained by applying a log function to the length information. Descriptions in relation to this are provided with reference to formula 710 of FIG. 7. The calculation count may mean reference times in a calculation operation. The calculation count may be described as target times, reference values and the like.

The electronic apparatus 100 may obtain a unit vector based on the length information N (S640).

The electronic apparatus 100 may apply the calculation count x, the unit vector, the first ciphertext A to a first function to obtain first intermediate information Ak (S650). Descriptions in relation to this are provided with reference to formula 730 of FIG. 7.

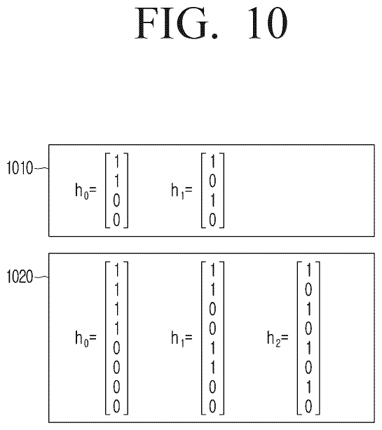

The electronic apparatus 100 may obtain filter information hk based on the length information N (S660). The filter information may be described as a filter vector, a selection vector or a mask vector. In the case of filter information, a plurality of elements may be 1. The filter information may include a vector selecting or emphasizing a specific position at the same time. The filter information may be described as a multi-hot vector based on a selection of a plurality of positions. Descriptions in relation to this are provided with reference to FIG. 10.

The electronic apparatus 100 may apply the calculation count x, the unit vector, the filter intermediate information Ak, and the filter information hk to a second function to obtain second intermediate information Bk (S670). Descriptions in relation to this are provided with reference to formula 740 of FIG. 7.

The electronic apparatus 100 may apply a plurality of intermediate values included in the second intermediate information Bk to a third function to obtain a second ciphertext (S680). Descriptions in relation to this are provided with reference to formula 750 of FIG. 7.

FIG. 7 is a view provided to explain an algorithm for converting a binary vector into a one-hot vector, according to one embodiment.

Referring to embodiment 710 of FIG. 7, a first ciphertext A may include N numbers of components. The electronic apparatus 100 may obtain length information N of the first ciphertext A.

Each of the components may be expressed as a_ij. The first ciphertext A may indicate a homomorphically encrypted binary vector. The first ciphertext A may have a value of 0 or 1. Additionally, a_ij may be 0 or 1.

As one example, the number of components included in the first ciphertext A may be 2ⁿ. The electronic apparatus 100 may obtain calculation count x based on log_2(N).

Referring to embodiment 720 of FIG. 7, the electronic apparatus 100 may obtain a unit vector. The unit vector may be generated based on the length information N. The electronic apparatus 100 may obtain a unit vector corresponding to the length information N. The electronic apparatus 100 may obtain a unit vector \vec{1} having a value of 1 by as many as the number N of components included in the first ciphertext A.

Referring to formula 730 of FIG. 7, the electronic apparatus 100 may obtain first intermediate information Ak by using a first function. The first function may be described as a first algorithm. The electronic apparatus 100 may apply the unit vector \vec{1} and the first ciphertext A to the first function to obtain first intermediate information Ak.

The electronic apparatus 100 may obtain the first intermediate information Ak by as much as a value x−1 at which 1 is deducted from the calculation count x. Considering an initial value A₀ of the first ciphertext A, the electronic apparatus 100 may obtain a total of x−1 numbers of the first intermediate information Ak.

The electronic apparatus 100 may obtain a first value \vec{1}−Aₖ₋₁ at which a previous intermediate value Aₖ₋₁ is deducted from the unit vector \vec{1}.

The electronic apparatus 100 may use a rotation function rot( ). The rotation function may rotate a component by a predetermined value. The rotation function may be a function rotating a component by a value of

$$\frac{N}{{2}^{k}}$$

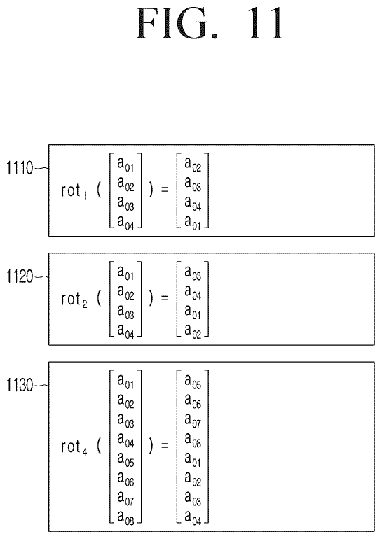

at which the length N of the first ciphertext A is divided by as much as 2^{k}. The rotation function is described in detail with reference to FIG. 11.

The electronic apparatus 100 may obtain a second value

$${rot}_{\frac{N}{{2}^{k}}} ( {A}_{k - 1} )$$

in which the rotation function is applied to the previous intermediate value Aₖ₋₁. The electronic apparatus 100 may obtain a third value

$$\vec{1} - {rot}_{\frac{N}{{2}^{k}}} ( {A}_{k - 1} )$$

at which the second value

$${rot}_{\frac{N}{{2}^{k}}} ( {A}_{k - 1} )$$

is deducted from the unit vector \vec{1}.

The electronic apparatus 100 may multiply the first value \vec{1}−Aₖ₋₁ and the third value

$$\vec{1} - {rot}_{\frac{N}{{2}^{k}}} ( {A}_{k - 1} )$$

to obtain a fourth value

$$( \vec{1} - {A}_{k - 1} ) ( \vec{1} - {rot}_{\frac{N}{{2}^{k}}} ( {A}_{k - 1} ) .$$

The electronic apparatus 100 may obtain first intermediate information Ak by deducting the fourth value

$$( \vec{1} - {A}_{k - 1} ) ( \vec{1} - {rot}_{\frac{N}{{2}^{k}}} ( {A}_{k - 1} )$$

from the unit vector \vec{1}.

As one example, k may be increased by a value x−1 at which 1 is deducted from x. The electronic apparatus 100 may obtain the first intermediate information Ak by as many as x−1 numbers.

In formula 730 of FIG. 7, Aₖ may indicate a function of grouping elements included in Aₖ₋₁ in predetermined numbers (e.g., two) to perform an OR calculation.

Referring to formula 740 of FIG. 7, the electronic apparatus 100 may obtain second intermediate information Bk by using a second function. The second function may be described as a second algorithm. The electronic apparatus 100 may apply the unit vector \vec{1}, the first intermediate information Ak and filter information hk to the second function to obtain the second intermediate information Bk.

The electronic apparatus 100 may obtain a fifth value Aₖ·hₖ at which the first intermediate information Ak and the filter information hk are multiplied.

The electronic apparatus 100 may apply the rotation function to the fifth value Aₖ·hₖ.

The rotation function may rotate a component by a predetermined value. The rotation function may be a function rotating a component by a value of

$$\frac{N}{{2}^{k + 1}}$$

at which the length N of the first ciphertext A is divided by as much as 2^{k+1}. The rotation function is described in detail with reference to FIG. 11.

The electronic apparatus 100 may apply a sixth value in

$${rot}_{\frac{N}{{2}^{k + 1}}} ( {A}_{k} \cdot {h}_{k} )$$

which the fifth value Aₖ·hₖ is applied to the rotation function.

The electronic apparatus 100 may obtain a seventh value

$$\vec{1} - {rot}_{\frac{N}{{2}^{k + 1}}} ( {A}_{k} \cdot {h}_{k} )$$

at which the sixth value

$${rot}_{\frac{N}{{2}^{k + 1}}} ( {A}_{k} \cdot {h}_{k} )$$

is deducted from the unit vector \vec{1}.

The electronic apparatus 100 may obtain the second intermediate information Bk by multiplying the first intermediate information Ak by the seventh value

$$\vec{1} - {rot}_{\frac{N}{{2}^{k + 1}}} ( {A}_{k} \cdot {h}_{k} ) .$$

The electronic apparatus 100 may obtain the second intermediate information Bk including a plurality of intermediate values while increasing k from 0 up to x−1.

In formula 740 of FIG. 7, Bₖ may indicate a function that groups elements included in Aₖ into predetermined numbers (e.g., two) such that a maximum of one 1 is left.

Referring to formula 750 of FIG. 7, the electronic apparatus 100 may obtain a second ciphertext C by using a third function. The third function may be used to obtain a result value B₀·B₁· . . . ·Bₓ₋₁ at which a plurality of second intermediate information Bk is multiplied. The electronic apparatus 100 may obtain the result value B₀·B₁· . . . ·Bₓ₋₁ as a second ciphertext C.

In the following description, a row vector may be used during a calculation process. However, a column vector may be used instead of the row vector depending on embodiments. Accordingly, various vector types may be used to generate a one-hot vector in addition to a calculation with respect to a row vector disclosed in the following description.

An input ciphertext may have N numbers of components (or slots). The electronic apparatus 100 may divide N numbers of components into

$$\frac{N}{{2}^{k}}$$

numbers of groups. If there is even one 1 in a divided group, Aₖ may be 1. If there is no 1 in a divided group, Aₖ may be 0.

The size of each of the groups may be 2^{k}. Accordingly, as k is increased, the size of the group may be increased gradually. As one example, a plurality of groups divided in a previous step k−1 may be included in one group divided in a following step k.

Additionally, Bₖ may be a function grouping components (or elements) of the divided groups into as many as predetermined numbers (e.g., two) and leaving a maximum of only one 1 among the grouped components.

For efficiency in a calculation, Aₖ, Bₖ may be comprised of a vector of a

$$\frac{N}{{2}^{k}}$$

length in which N numbers of entire slots are repeated 2^{k} times.

Multiplication from B₀ to Bₖ may be a vector where a maximum of only one 1 is left with respect to each of the groups divided in step k+1. In the case of k=x−1, a maximum of only one 1 may be left among the entire slots, in the second ciphertext C.

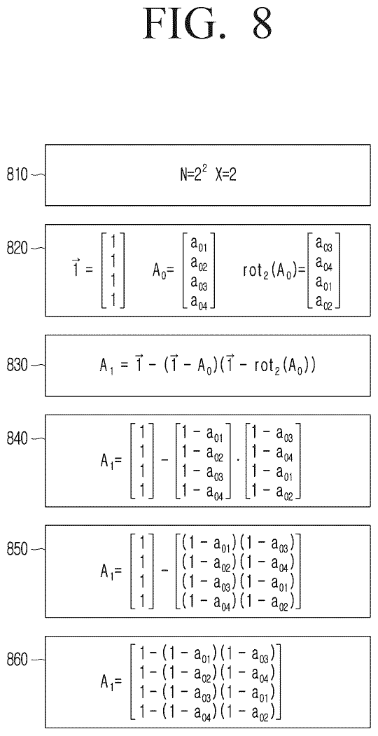

FIG. 8 is a view provided to explain a calculation process based on a first function, according to one embodiment.

Referring to embodiment 810 of FIG. 8, assume that the length information N of the first ciphertext A is 4. The length of the first ciphertext A may vary. The electronic apparatus 100 may obtain the calculation count x as 2.

Referring to formula 820 of FIG. 8, the electronic apparatus 100 may obtain a

$$\vec{1} = [ \begin{matrix}1 \\ 1 \\ 1 \\ 1\end{matrix} ] ,$$

unit vector an initial value

$${A}_{0} = [ \begin{matrix}{a}_{01} \\ {a}_{02} \\ {a}_{03} \\ {a}_{04}\end{matrix} ]$$

of the first ciphertext A.

The electronic apparatus 100 may obtain a first value \vec{1}−A₀ by deducting a pervious intermediate value A₀ from the unit vector \vec{1}. The previous intermediate value A₀ may be described as an initial value.

The electronic apparatus 100 may use a rotation function rot( ). The rotation function may rotate a component by a predetermined value. The rotation function may be a function rotating a component by a value of 2 at which the length 4 of the first ciphertext A is divided by as much as 2¹. The rotation function is described in detail with reference to FIG. 11.

The electronic apparatus 100 may obtain a second value rot₂(A₀) at which the rotation function is applied to the initial value A₀. The electronic apparatus 100 may obtain a third value \vec{1}−rot₂(A₀) at which the second value rot₂(A₀) is deducted from the unit vector \vec{1}.

The electronic apparatus 100 may obtain a fourth value (\vec{1}−A₀)(\vec{1}−rot₂(A₀)) by multiplying the first value \vec{1}−A₀ and the third value \vec{1}−rot₂(A₀).

The electronic apparatus 100 may obtain a first intermediate value A₁ of first intermediate information Ak by deducting the fourth value (\vec{1}−A₀)(\vec{1}−rot₂(A₀)) from the unit vector \vec{1}.

Referring to formula 840 of FIG. 8, the unit vector \vec{1} may be expressed as

$$[ \begin{matrix}1 \\ 1 \\ 1 \\ 1\end{matrix} ] .$$

The first value \vec{1}−A₀ may be expressed as

$$[ \begin{matrix}1 - {a}_{01} \\ 1 - {a}_{02} \\ 1 - {a}_{03} \\ 1 - {a}_{04}\end{matrix} ] .$$

The third value \vec{1}−rot₂(A₀) may be expressed as

$$[ \begin{matrix}1 - {a}_{03} \\ 1 - {a}_{04} \\ 1 - {a}_{01} \\ 1 - {a}_{02}\end{matrix} ] .$$

The fourth value (\vec{1}−A₀)(\vec{1}−rot₂(A₀)) may be expressed as

$$[ \begin{matrix}1 - {a}_{01} \\ 1 - {a}_{02} \\ 1 - {a}_{03} \\ 1 - {a}_{04}\end{matrix} ] \cdot [ \begin{matrix}1 - {a}_{03} \\ 1 - {a}_{04} \\ 1 - {a}_{01} \\ 1 - {a}_{02}\end{matrix} ] .$$

The first intermediate value A₁ may be expressed as

$$[ \begin{matrix}1 \\ 1 \\ 1 \\ 1\end{matrix} ] - [ \begin{matrix}1 - {a}_{01} \\ 1 - {a}_{02} \\ 1 - {a}_{03} \\ 1 - {a}_{04}\end{matrix} ] \cdot [ \begin{matrix}1 - {a}_{03} \\ 1 - {a}_{04} \\ 1 - {a}_{01} \\ 1 - {a}_{02}\end{matrix} ] .$$

Referring to formula 850 of FIG. 8, the fourth value (\vec{1}−A₀)(\vec{1}−rot₂(A₀)) may be expressed as

$$[ \begin{matrix}( 1 - {a}_{01} ) ( 1 - {a}_{03} ) \\ ( 1 - {a}_{02} ) ( 1 - {a}_{04} ) \\ ( 1 - {a}_{03} ) ( 1 - {a}_{01} ) \\ ( 1 - {a}_{04} ) ( 1 - {a}_{02} )\end{matrix} ] .$$

Referring to formula 860 of FIG. 8, the first intermediate value A₁ is expressed as

$$[ \begin{matrix}1 - ( 1 - {a}_{01} ) ( 1 - {a}_{03} ) \\ 1 - ( 1 - {a}_{02} ) ( 1 - {a}_{04} ) \\ 1 - ( 1 - {a}_{03} ) ( 1 - {a}_{01} ) \\ 1 - ( 1 - {a}_{04} ) ( 1 - {a}_{02} )\end{matrix} ] .$$

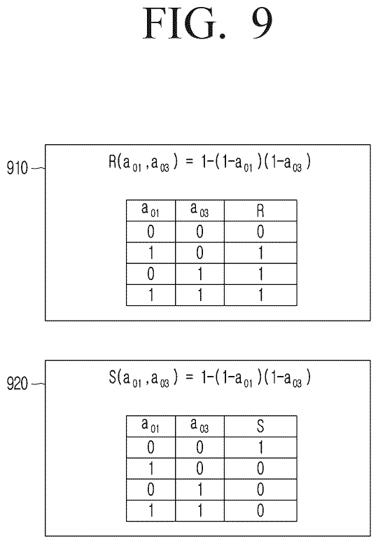

FIG. 9 is a view provided to explain a result of a partial formula used in an algorithm, according to one embodiment.

Formula 910 of FIG. 9 may indicate an OR function. The OR function may be a function returning 1 in the case where one of input factors is 1. The OR function may return 1 in the case where one of a01 or a03 is 1. The OR function may return 0 in the case where a01 and a03 are both 0.

Formula 920 of FIG. 9 may indicate an XOR function. The XOR function may be a function returning 0 in the case where one of input factors is 1. The XOR function may return 0 in the case where one of a01 or a03 is 1. The XOR function may return 1 in the case where a01 and a03 are both 0.

FIG. 10 is a view provided to explain filter information, according to one embodiment.

Referring to embodiment 1010 of FIG. 10, the electronic apparatus 100 may indicate filter information hk that is used in the case where the length of the first ciphertext A is 4.

Referring to embodiment 1020 of FIG. 10, the electronic apparatus 100 may indicate filter information hk that is used in the case where the length of the first ciphertext A is 8.

The filter information hk may indicate a filter vector emphasizing or removing data of a specific portion. The filter information hk may vary depending on a calculation step.

A plurality of filters h1, h2, . . . included in the filter information hk may have the same number of 1s.

FIG. 11 is a view provided to explain a rotation function, according to one embodiment.

Embodiment 1110 of FIG. 11 may indicate a rotation function rotating by 1.

Embodiment 1120 of FIG. 11 may indicate a rotation function rotating by 2.

Embodiment 1130 of FIG. 11 may indicate a rotation function rotating by 4.

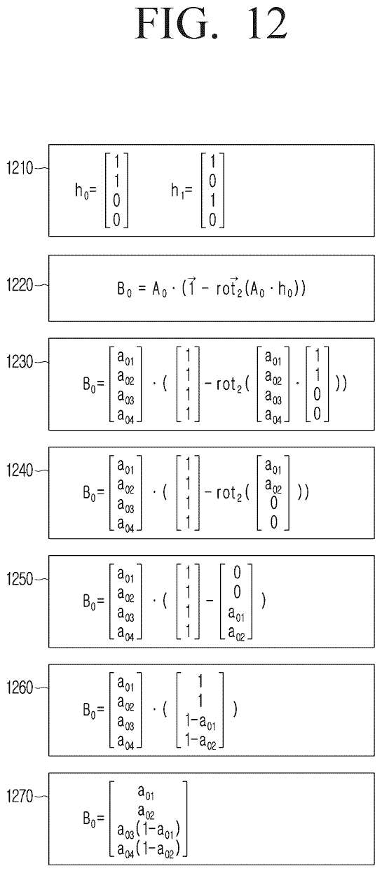

FIG. 12 is a view provided to explain a first calculation process based on a second function, according to one embodiment.

Referring to embodiment 1210 of FIG. 12, the filter information hk may include a first filter h₀ and a second filter h₁.

Referring to formula 1220 of FIG. 12, the electronic apparatus 100 may obtain a second intermediate value B₀.

The electronic apparatus 100 may obtain second intermediate information Bk by using a second function. The second function may be described as a second algorithm. The electronic apparatus 100 may apply the unit vector \vec{1}, the initial value A₀, and the first filter h₀ to the second function to obtain the second intermediate information Bk.

The electronic apparatus 100 may obtain a fifth value A₀·h₀ at which the initial value A₀ and the first filter h₀ are multiplied.

The electronic apparatus 100 may apply a rotation function to the fifth value ( ).

The rotation function may rotate a component by a predetermined value. The rotation function may be a function rotating a component by a value of 2 at which the length 4 of the first ciphertext A is divided by as much as 2¹. The rotation function is described in detail with reference to FIG. 11.

The electronic apparatus 100 may a sixth value rot₂(A₀·h₀) at which the fifth value A₀·h₀ is applied to the rotation function.

The electronic apparatus 100 may obtain a seventh value \vec{1}−rot₂(A₀·h₀) at which the sixth value rot₂(A₀·h₀) is deducted from the unit vector \vec{1}.

The electronic apparatus 100 may obtain the second intermediate value B₀ by multiplying the initial value A₀ by the seventh value \vec{1}−rot₂(A₀·h₀).

Referring to formula 1230 of FIG. 12, the initial value A₀ may be expressed as

$$[ \begin{matrix}{a}_{01} \\ {a}_{02} \\ {a}_{03} \\ {a}_{04}\end{matrix} ] .$$

The unit vector \vec{1} may be expressed as

$$[ \begin{matrix}1 \\ 1 \\ 1 \\ 1\end{matrix} ] .$$

The first filter h₀ may be expressed as

$$[ \begin{matrix}1 \\ 0 \\ 1 \\ 0\end{matrix} ] .$$

Referring to formula 1240 of FIG. 12, the fifth value A₀·h₀ may be expressed as

$$[ \begin{matrix}{a}_{01} \\ {a}_{02} \\ 0 \\ 0\end{matrix} ] .$$

Referring to formula 1250 of FIG. 12, the sixth value rot₂(A₀·h₀) may be expressed as

$$[ \begin{matrix}0 \\ 0 \\ {a}_{01} \\ {a}_{02}\end{matrix} ] .$$

Referring to formula 1260 of FIG. 12, the seventh value \vec{1}−rot₂(A₀·h₀) may be expressed as

$$[ \begin{matrix}1 \\ 1 \\ 1 - {a}_{01} \\ 1 - {a}_{02}\end{matrix} ] .$$

Referring to formula 1270 of FIG. 12, the second intermediate value B₀ may be expressed as

$$[ \begin{matrix}{a}_{01} \\ {a}_{02} \\ {a}_{03} ( 1 - {a}_{01} ) \\ {a}_{04} ( 1 - {a}_{02} )\end{matrix} ] .$$

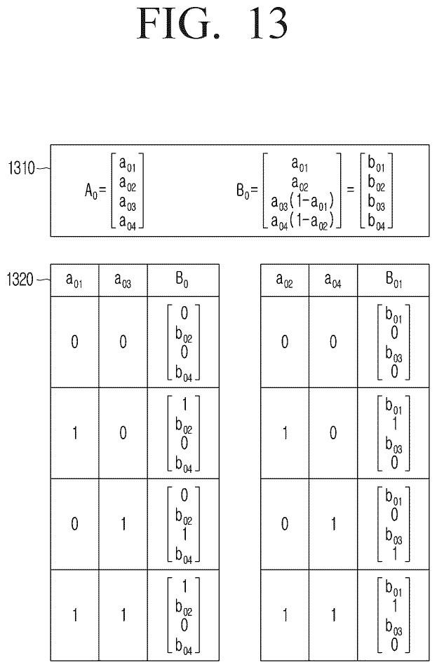

FIG. 13 is a view provided to explain a result of an application of input data to a second function, according to one embodiment.

Embodiment 1310 of FIG. 13 may indicate a second intermediate value

$${B}_{0} = [ \begin{matrix}{a}_{01} \\ {a}_{02} \\ {a}_{03} ( 1 - {a}_{01} ) \\ {a}_{04} ( 1 - {a}_{02} )\end{matrix} ] = [ \begin{matrix}{b}_{01} \\ {b}_{02} \\ {b}_{03} \\ {b}_{04}\end{matrix} ] .$$

corresponding to an initial value

$${A}_{0} = [ \begin{matrix}{a}_{01} \\ {a}_{02} \\ {a}_{03} \\ {a}_{04}\end{matrix} ] .$$

Embodiment 1320 of FIG. 13 may indicate a result of a second intermediate value B₀ based on a01 and a03.

Embodiment 1320 of FIG. 13 may indicate a result of the second intermediate value B₀ based on a02 and a04.

A second function may determine b01 as 1 and b03 as 0 in the case where a01 and a03 are both 1.

The second function may determine b02 as 1 and b04 as 0 in the case where a02 and a04 are both 1.

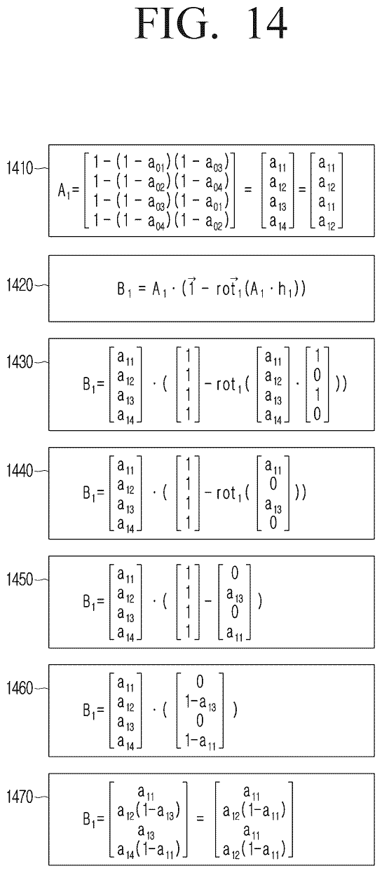

FIG. 14 is a view provided to explain a second calculation process based on a second function, according to one embodiment.

Referring to embodiment 1410 of FIG. 14, the electronic apparatus 100 may express formula 860 of FIG. 8 as

$$[ \begin{matrix}{a}_{11} \\ {a}_{12} \\ {a}_{13} \\ {a}_{14}\end{matrix} ] .$$

### In

$$[ \begin{matrix}{a}_{11} \\ {a}_{12} \\ {a}_{13} \\ {a}_{14}\end{matrix} ] ,$$

data in a first row and a third row may be the same, and data in a second row and fourth row may be the same. Accordingly,

$$[ \begin{matrix}{a}_{11} \\ {a}_{12} \\ {a}_{13} \\ {a}_{14}\end{matrix} ]$$

may be expressed as

$$[ \begin{matrix}{a}_{11} \\ {a}_{12} \\ {a}_{11} \\ {a}_{12}\end{matrix} ] .$$

Referring to formula 1420 of FIG. 14, the electronic apparatus 100 may obtain a third intermediate value B₁. The electronic apparatus 100 may obtain a second filter h₁.

The electronic apparatus 100 may obtain an eighth value A₁·h₁ at which a first intermediate value A₁ and the second filter h₁ are multiplied. The electric apparatus 100 may obtain a ninth value rot₁(A₁·h₁) to which a rotation function rotating the eighth value A₁·h₁ by 1 is applied.

The electronic apparatus 100 may obtain a tenth value \vec{1}−rot₁(A₁·h₁) at which the ninth value rot₁(A₁·h₁) is deducted from a unit vector \vec{1}.

The electronic apparatus 100 may obtain a third intermediate value B₁ by multiplying the first intermediate value A₁ and the tenth value A₁−rot₁(A₁·h₁).

Referring to formula 1430 of FIG. 14, the first intermediate value A₁ may be expressed as

$$[ \begin{matrix}{a}_{11} \\ {a}_{12} \\ {a}_{13} \\ {a}_{14}\end{matrix} ] .$$

The unit vector \vec{1} may be expressed as

$$[ \begin{matrix}1 \\ 1 \\ 1 \\ 1\end{matrix} ] .$$

The second filter h₁ may be expressed as

$$[ \begin{matrix}1 \\ 0 \\ 1 \\ 0\end{matrix} ] .$$

Referring to formula 1440 of FIG. 14, the eighth value A₁·h₁ may be expressed as

$$[ \begin{matrix}{a}_{11} \\ 0 \\ {a}_{13} \\ 0\end{matrix} ] .$$

Referring to formula 1450 of FIG. 14, the ninth value rot₁(A₁·h₁) may be expressed as

$$[ \begin{matrix}0 \\ {a}_{13} \\ 0 \\ {a}_{11}\end{matrix} ] .$$

Referring to formula 1460 of FIG. 14, the tenth value \vec{1}−rot₁(A₁·h₁) may be expressed as

$$[ \begin{matrix}1 \\ 1 - {a}_{13} \\ 1 \\ 1 - {a}_{11}\end{matrix} ] .$$

Referring to formula 1470 of FIG. 14, the third intermediate value B₁ may be expressed as

$$[ \begin{matrix}{a}_{11} \\ {a}_{12} ( 1 - {a}_{13} ) \\ {a}_{13} \\ {a}_{14} ( 1 - {a}_{11} )\end{matrix} ] .$$

As described in embodiment 1410, a first row and a third row may be the same, and a second row and a fourth row may be the same. Accordingly, the third intermediate value B₁ may be expressed as

$$[ \begin{matrix}{a}_{11} \\ {a}_{12} ( 1 - {a}_{11} ) \\ {a}_{11} \\ {a}_{12} ( 1 - {a}_{11} )\end{matrix} ] .$$

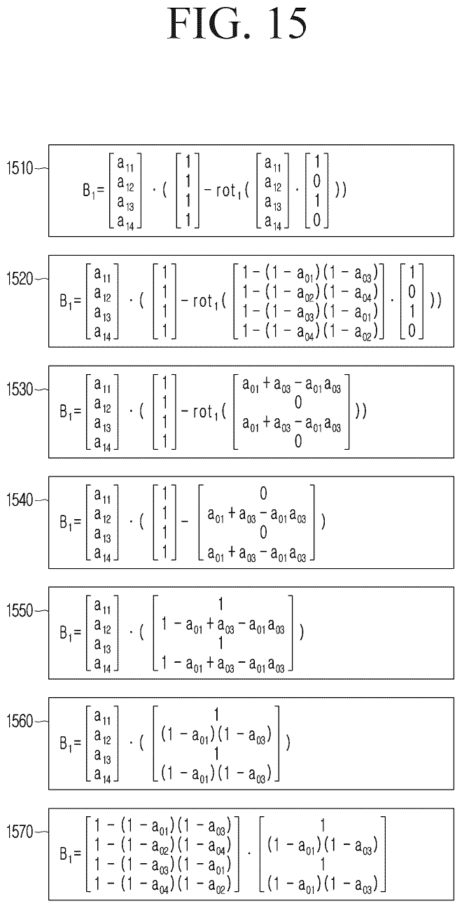

FIG. 15 is a view provided to explain a second calculation process based on a second function, according to one embodiment.

Formula 1510 of FIG. 15 may correspond to formula 1430 of FIG. 14.

Referring to formula 1520 of FIG. 15,

$$[ \begin{matrix}{a}_{11} \\ {a}_{12} \\ {a}_{13} \\ {a}_{14}\end{matrix} ]$$

may be expressed as

$$[ \begin{matrix}1 - ( 1 - {a}_{01} ) ( 1 - {a}_{03} ) \\ 1 - ( 1 - {a}_{02} ) ( 1 - {a}_{04} ) \\ 1 - ( 1 - {a}_{03} ) ( 1 - {a}_{01} ) \\ 1 - ( 1 - {a}_{04} ) ( 1 - {a}_{02} )\end{matrix} ] .$$

Referring to formula 1530 of FIG. 15, an eighth value A₁·h₁ may be expressed as

$$[ \begin{matrix}{a}_{01} + {a}_{03} - {a}_{01} {a}_{03} \\ 0 \\ {a}_{01} + {a}_{03} - {a}_{01} {a}_{03} \\ 0\end{matrix} ] .$$

Referring to formula 1540 of FIG. 15, a ninth value rot₁(A₁·h₁) may be expressed as

$$[ \begin{matrix}0 \\ {a}_{01} + {a}_{03} - {a}_{01} {a}_{03} \\ 0 \\ {a}_{01} + {a}_{03} - {a}_{01} {a}_{03}\end{matrix} ] .$$

Referring to formula 1550 of FIG. 15, a tenth value 1-rot (A₁·h₁) may be expressed as

$$[ \begin{matrix}1 \\ 1 - {a}_{01} - {a}_{03} + {a}_{01} {a}_{03} \\ 1 \\ 1 - {a}_{01} - {a}_{03} + {a}_{01} {a}_{03}\end{matrix} ] .$$

Referring to formula 1560 of FIG. 15,

$$[ \begin{matrix}1 \\ 1 - {a}_{01} - {a}_{03} + {a}_{01} {a}_{03} \\ 1 \\ 1 - {a}_{01} - {a}_{03} + {a}_{01} {a}_{03}\end{matrix} ]$$

may be expressed as

$$[ \begin{matrix}1 \\ ( 1 - {a}_{01} ) ( 1 - {a}_{03} ) \\ 1 \\ ( 1 - {a}_{01} ) ( 1 - {a}_{03} )\end{matrix} ] .$$

Referring to formula 1570 of FIG. 15,

$$[ \begin{matrix}{a}_{11} \\ {a}_{12} \\ {a}_{13} \\ {a}_{14}\end{matrix} ]$$

may be expressed as

$$[ \begin{matrix}1 - ( 1 - {a}_{01} ) ( 1 - {a}_{03} ) \\ 1 - ( 1 - {a}_{02} ) ( 1 - {a}_{04} ) \\ 1 - ( 1 - {a}_{03} ) ( 1 - {a}_{01} ) \\ 1 - ( 1 - {a}_{04} ) ( 1 - {a}_{02} )\end{matrix} ] .$$

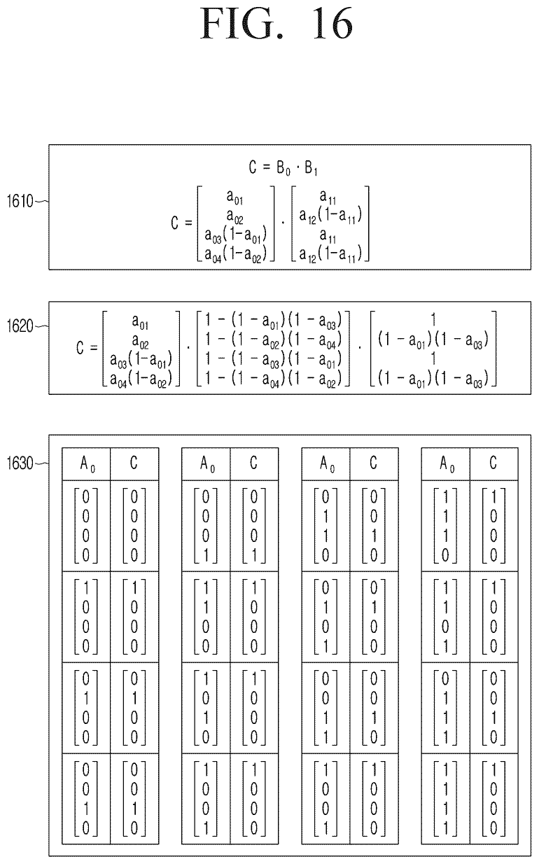

FIG. 16 is a view provided to explain a one-hot vector corresponding to input data, according to one embodiment.

Referring to embodiment 1610 of FIG. 16, the electronic apparatus 100 may obtain a result value C by multiplying a second intermediate value B₀ and a third intermediate value B₁. The result value C may be a second ciphertext C indicating a one-hot vector.

The second intermediate value B₀ may be expressed as

$$[ \begin{matrix}{a}_{01} \\ {a}_{02} \\ {a}_{03} ( 1 - {a}_{01} ) \\ {a}_{04} ( 1 - {a}_{02} )\end{matrix} ]$$

based on formula 1270 of FIG. 12.

$$[ \begin{matrix}{a}_{11} \\ {a}_{12} ( 1 - {a}_{11} ) \\ {a}_{11} \\ {a}_{12} ( 1 - {a}_{11} )\end{matrix} ]$$

The third intermediate value B₁ may be expressed as based on formula 1470 of FIG. 14.

Referring to formula 1620 of FIG. 16, the third intermediate value B₁ may be expressed as

$$[ \begin{matrix}1 - ( 1 - {a}_{01} ) ( 1 - {a}_{03} ) \\ 1 - ( 1 - {a}_{02} ) ( 1 - {a}_{04} ) \\ 1 - ( 1 - {a}_{03} ) ( 1 - {a}_{01} ) \\ 1 - ( 1 - {a}_{04} ) ( 1 - {a}_{02} )\end{matrix} ] \cdot [ \begin{matrix}1 \\ ( 1 - {a}_{01} ) ( 1 - {a}_{03} ) \\ 1 \\ ( 1 - {a}_{01} ) ( 1 - {a}_{03} )\end{matrix} ]$$

based on formula 1570 of FIG. 15.

Referring to embodiment 1630 of FIG. 16, the electronic apparatus 100 may indicate a result value C based on an initial value A₀.

In the case where all components at the initial value A₀ are 0, the result value C may also be 0.

In the case where there is one 1 at the initial value A₀, the initial value A₀ and the result value C may be the same.

In the case where there are two or more 1s at the initial value A₀, the electronic apparatus 100 may obtain a result value C having only one value of 1. A position of one value of 1 may be determined based on a priority order of a first row a01, a third row a03, a second row a02, a fourth row a04.

As one example, in the case where the initial value A₀ is

$$[ \begin{matrix}1 \\ 0 \\ 1 \\ 0\end{matrix} ] ,$$

the result value C may be

$$[ \begin{matrix}1 \\ 0 \\ 0 \\ 0\end{matrix} ] .$$

As one example, in the case where the initial value A₀ is

$$[ \begin{matrix}0 \\ 1 \\ 1 \\ 0\end{matrix} ] ,$$

the result value C may be

$$[ \begin{matrix}0 \\ 0 \\ 1 \\ 0\end{matrix} ] .$$

As one example, in the case where the initial value A₀ is

$$[ \begin{matrix}0 \\ 1 \\ 0 \\ 1\end{matrix} ] ,$$

the result value C may be

$$[ \begin{matrix}0 \\ 1 \\ 0 \\ 0\end{matrix} ] .$$

The electronic apparatus 100 may obtain the second ciphertext C indicating the result value C by using a first function, a second function and a third function to generate a one-hot vector. The electronic apparatus 100 may obtain the second ciphertext C maintaining a value of 1, based on the priority order of the first row a01, the third row a03, the second row a02, the fourth row a04, with respect to a first ciphertext A.

The electronic apparatus 100 may obtain a one-hot vector efficiently with respect to a homomorphically encrypted binary vector by using the first function, the second function and the third function.

The electronic apparatus 100 may perform a calculation as many as O(N) times, to obtain the one-hot vector, without performing iteration.

The electronic apparatus 100 may obtain the result value C based on a plurality of iterations.

In the case where Aₖ, Bₖ, C and the like are used to obtain the one-hot vector, the electronic apparatus 100 may perform a calculation as many as O (log N) times.

Accordingly, an iteration-based one-hot vector conversion of the electronic apparatus 100 may enable a calculation faster than a calculation ordinarily performed O(N) times.

FIG. 17 is a view provided to explain an algorithm for converting a binary vector into a one-hot vector, according to one embodiment.

Referring to embodiment 1710 of FIG. 17, a first ciphertext A may include N numbers of components. The electronic apparatus 100 may obtain length information N of the first ciphertext A.

Each of the components may be expressed as a_ij. The first ciphertext A may indicate a homomorphically encrypted binary vector. The first ciphertext A may have a value of 0 or 1. Additionally, a_ij may be 0 or 1.

An embodiment in which the number of components included in the first ciphertext A is 2ⁿ is described with reference to FIG. 7. An embodiment in which the number N of components included in the first ciphertext A is in the form of multiplication of an integer (N=t₁·t₂ . . . tₓ₋₁) is described with reference to FIG. 17. Herein, x and tj may be integers. Additionally, x may be a number indicating calculation count.

Additionally, k may be a number indicating a repetitive calculation reference. With respect to a first calculation, k may equal 1, and with respect to a second calculation, k may equal 2.

Further, Tₖ may be a value used in a specific calculation may be Tₖ may be t₁·t₂ . . . tₖ. Furthermore, k may be increased from 1 to x−1.

Referring to formula 1720 of FIG. 17, Aₖ may be calculated based on

$${A}_{k} = \vec{1} - ( \vec{1} - {A}_{k - 1} ) \cdot ( \vec{1} - {rot}_{\frac{N}{{T}_{k}}} ( {A}_{k - 1} ) ) \cdot ( \vec{1} - {rot}_{\frac{N \cdot 2}{{T}_{k}}} ( {A}_{k - 1} ) ) … ( \vec{1} - {rot}_{\frac{N ( {t}_{k} - 1 )}{{T}_{k}}} ( {A}_{k - 1} ) ) .$$

Referring to formula 1730 of FIG. 17, Aₖ may be expressed by

$${A}_{k} = \vec{1} - {⊙}_{j = 0 … {t}_{k - 1}} ( \vec{1} - {rot}_{\frac{N \cdot j}{{T}_{k}}} ( {A}_{k - 1} ) ) .$$

Herein, ⊙ may be a symbol indicating a multiplication calculation of each vector component from j=0 to tₖ₋₁. Additionally, k may be increased from 1 to x−1.

Referring to formula 1740 of FIG. 17, Bₖ may be calculated based on

$${B}_{k} = {A}_{k} \cdot ( \vec{1} - {rot}_{\frac{N}{{T}_{k + 1}}} ( {A}_{k} \cdot {h}_{k , 1} ) ) … ( \vec{1} - {rot}_{\frac{N ( {t}_{k + 1} - 1 )}{{T}_{k + 1}}} ( {A}_{k} \cdot {h}_{k , {t}_{k + 1} - 1} ) ) .$$

Referring to formula 1750 of FIG. 17, may be expressed by Bₖ

$${A}_{k} \cdot {⊙}_{j = 1 … {t}_{k + 1} - 1} ( \vec{1} - {rot}_{\frac{N \cdot j}{{T}_{k + 1}}} ( {A}_{k} \cdot {h}_{kj} ) ) .$$

Additionally, k may be increased from 0 to x−1.

With respect to each k calculation, j may be increased from 1 to tₖ₊₁−1.

Referring to formula 1760 of FIG. 17, hₖⱼ may mean filter information. Additionally, hₖⱼ may be a matrix in the form of (1, 1, . . . , 1, 0, 0, . . . , 0) Additionally, hₖⱼ may be implemented as a row vector as shown in FIG. 10 rather than a column vector.

Further, nₖⱼ may be a vector of an N length where

$$\frac{N \cdot j}{{T}_{k + 1}}$$

numbers of 1 and

$$\frac{N \cdot ( {t}_{k + 1} - j )}{{T}_{k + 1}}$$

numbers of 0 are repeated Tₖ times.

Referring to formula 1770 of FIG. 17, a second ciphertext C may be calculated based on C=B₀·B₁· . . . ·Bₓ₋₁.

The methods, according to the embodiments described above, may be implemented in the form of an application that is installable in an existing electronic apparatus.

The methods, according to the embodiments described above, may be implemented only based on an upgrade of software or hardware of an existing electronic apparatus.

The embodiments described above may be performed through an embedded server provided in an electronic apparatus, or an external server of at least one of an electronic apparatus and a display device.

The embodiments described above may be implemented with software including instructions stored in a storage medium readable by a machine (e.g., a computer). The machine, as a device capable of calling the stored instructions from the storage medium and operating according to the called instructions, may include an electronic apparatus according to the disclosed embodiments. Based on instructions executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” only means that the storage medium includes no signal and is tangible, while the term does not differentiate semi-permanent or temporary storage of data in the storage medium.

According to the embodiments described above, the methods may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store. In the case of online distribution, at least part of the computer program product may be stored at least temporarily, or generated temporarily in a storage medium such as a server of a manufacturer, a server of an application store, or memory of a relay server.

Further, each of the elements (e.g., a module or a program) according to the embodiments described above may be comprised of a single entity or a plurality of entities, and some of the corresponding sub elements described above may be omitted, or another sub element may be further included in the embodiments. Alternatively or additionally, some of the elements (e.g., modules or programs) may be integrated into one entity to perform functions performed by each corresponding element prior to integration in an identical or similar manner. Operations performed by a module, a program, or another element, according to the embodiments, may be executed sequentially, in parallel, repetitively, or heuristically, or at least some of the operations may be executed in a different order, omitted, or may include another operation.

While example embodiments of the present disclosure are illustrated and described above, embodiments of the disclosure are not limited to specific embodiments set forth herein, and certainly, various modifications thereof may be made by those skilled in the art to which the present disclosure pertains, without departing from the scope the disclosure claimed in the section of claims, and should not be understood as separating from the technical spirit of the disclosure.

1. An electronic apparatus comprising:
at least one processor including processing circuitry; and
memory,
wherein the at least one processor obtains a control instruction for generating a one-hot vector with respect to a first ciphertext comprised of a binary vector,
obtains length information of the first ciphertext,
obtains calculation count based on the length information,
obtains a unit vector corresponding to the length information, and
generates a second ciphertext that indicates a one-hot vector corresponding to the first ciphertext based on the first ciphertext, the length information, the calculation count and the unit vector.

2. The electronic apparatus of claim 1,
wherein the first ciphertext is a binary vector having a value of 0 or 1, and
the second ciphertext is a one-hot vector having only one value of 1.

3. The electronic apparatus of claim 1,
wherein the unit vector is a vector including a value of 1 by as much as the length information.

4. The electronic apparatus of claim 1,
wherein the first ciphertext is a homomorphically encrypted vector, and
the unit vector is a plaintext vector.

5. The electronic apparatus of claim 1,
wherein the at least one processor applies the calculation count, the unit vector and the first ciphertext to a first function to obtain first intermediate information,
obtains filter information based on the length information,
applies the calculation count, the unit vector, the first intermediate information and the filter information to a second function to obtain second intermediate information, and
applies a plurality of intermediate values included in the second intermediate information to a third function to obtain the second ciphertext.

6. The electronic apparatus of claim 5,
wherein the first function is a function indicating an OR calculation that identifies whether a value of 1 is present based on a predetermined group unit,
the second function is a function removing a value of 1 selectively based on a predetermined group unit, and
the third function is a function indicating a calculation of multiplying a plurality of intermediate values.

7. The electronic apparatus of claim 6,
wherein the length information is in a 2ⁿ form,
the calculation count are obtained based on log₂ N, and
N is the length information.

8. The electronic apparatus of claim 6,
wherein the first function is
$${A}_{k} = \vec{1} - ( \vec{1} - {A}_{k - 1} ) ( \vec{1} - {rot}_{\frac{N}{{2}^{k}}} ( {A}_{k - 1} ) )$$
$$k = 1 , … , x - 1 ,$$
k is a calculation unit increased from 1 to x−1,
Ak is the first intermediate information,
\vec{1} is the unit vector,
$${rot}_{\frac{N}{{2}^{k}}} ( {A}_{k - 1} )$$
is a function rotating a component in a predetermined direction by as much as
$$\frac{N}{{2}^{k}}$$
with respect to Aₖ₋₁, and
N is the length information.

9. The electronic apparatus of claim 8,
wherein the second function is
$${B}_{k} = {A}_{k} \cdot ( \vec{1} - {rot}_{\frac{N}{{2}^{k + 1}}} ( {A}_{k} \cdot {h}_{k} ) )$$
$$k = 0 , … , x - 1 ,$$
k is a calculation unit increased from 0 to x−1,
Bk is the second intermediate information,
hk is the filter information,
Aₖ·hₖ is a value of multiplication of the first intermediate information and the filter information,
$${rot}_{\frac{N}{{2}^{k + 1}}} ( {A}_{k} \cdot {h}_{k} )$$
is a function rotating a component in a predetermined direction by as much as
$$\frac{N}{{2}^{k + 1}}$$
with respect to Aₖ·hₖ, and
A₀ is the first ciphertext.

10. The electronic apparatus of claim 9,
wherein the third function is C=B₀·B₁· . . . ·Bₓ₋₁,
C is the second ciphertext, and
x is the calculation count.

11. A controlling method of an electronic apparatus, the method comprising:
obtaining a control instruction for generating a one-hot vector with respect to a first ciphertext comprised of a binary vector;
obtaining length information of the first ciphertext;
obtaining calculation count based on the length information;
obtaining a unit vector corresponding to the length information; and
generating a second ciphertext that indicates a one-hot vector corresponding to the first ciphertext based on the first ciphertext, the length information, the calculation count and the unit vector.

12. The method of claim 11,
wherein the first ciphertext is a binary vector having a value of 0 or 1, and
the second ciphertext is a one-hot vector having only one value of 1.

13. Then method of claim 11,
wherein the unit vector is a vector including a value of 1 by as much as the length information.

14. The method of claim 11,
wherein the first ciphertext is a homomorphically encrypted vector, and
the unit vector is a plaintext vector.

15. The method of claim 11,
wherein the obtaining a second ciphertext includes applying the calculation count, the unit vector and the first ciphertext to a first function to obtain first intermediate information,
obtaining filter information based on the length information,
applying the calculation count, the unit vector, the first intermediate information and the filter information to a second function to obtain second intermediate information, and
applying a plurality of intermediate values included in the second intermediate information to a third function to obtain the second ciphertext.

16. The method of claim 15,
wherein the first function is a function indicating an OR calculation that identifies whether a value of 1 is present based on a predetermined group unit,
the second function is a function removing a value of 1 selectively based on a predetermined group unit, and
the third function is a function indicating a calculation of multiplying a plurality of intermediate values.

17. The method of claim 16,
wherein the length information is in a 2ⁿ form,
the calculation count are obtained based on log₂ N, and
N is the length information.

18. The method of claim 16,
wherein the first function is
$${A}_{k} = \vec{1} - ( \vec{1} - {A}_{k - 1} ) ( \vec{1} - {rot}_{\frac{N}{{2}^{k}}} ( {A}_{k - 1} ) )$$
$$k = 1 , … , x - 1 ,$$
k is a calculation unit increased from 1 to x−1,
Aₖ is the first intermediate information,
\vec{1} is the unit vector,
$${rot}_{\frac{N}{{2}^{k}}} ( {A}_{k - 1} )$$
is a function rotating a component in a predetermined direction by as much as
$$\frac{N}{{2}^{k}}$$
with respect to Aₖ₋₁, and
N is the length information.

19. The method of claim 18,
wherein the second function is
$${B}_{k} = {A}_{k} \cdot ( \vec{1} - {rot}_{\frac{N}{{2}^{k + 1}}} ( {A}_{k} \cdot {h}_{k} ) )$$
$$k = 0 , … , x - 1 ,$$
k is a calculation unit increased from 0 to x−1,
Bk is the second intermediate information,
hk is the filter information,
Aₖ·hₖ is a value of multiplication of the first intermediate information and the filter information,
$${rot}_{\frac{N}{{2}^{k + 1}}} ( {A}_{k} \cdot {h}_{k} )$$
is a function rotating a component in a predetermined direction by as much as
$$\frac{N}{{2}^{k + 1}}$$
with respect to Aₖ·hₖ, and
A₀ is the first ciphertext.

20. The method of claim 19,
wherein the third function is C=B₀·B₁· . . . ·Bₓ₋₁,
C is the second ciphertext, and
x is the calculation count.
